(19) United States
(12) Patent Application Publication
(10) Pub. No.: US 2011/0123972 A1
(43) Pub. Date: May 26, 2011

(54) SYSTEM FOR AUTOMATIC PRODUCTION OF LECTURES AND PRESENTATIONS FOR LIVE OR ON-DEMAND PUBLISHING AND SHARING

(76) Inventor: Lior Friedman, Modi'in (IL)

(21) Appl. No.: 13/057,166

(22) PCT Filed: Aug. 3, 2009
(86) PCT No.: PCT/IL2009/000757

§ 371 Date: Feb. 7, 2011

Related U.S. Application Data
(60) Provisional application No. 61/085,882, filed on Aug. 4, 2008.

(51) Int. Cl. G09B 5/06

(52) U.S. Cl. 434/308

(57) ABSTRACT

A system for automatically capturing, producing and publishing frontal information from lecture halls, comprising: (a) a Lecture hall capture module, consisting of video cameras, microphones, peripheral equipment and video analysis software for capturing of an on-going event in the hall; (b) a Lecturer GUI module for allowing said lecturer to add data into the lesson database, to control the capturing components to control the database generation, to control the database upload process and to communicate with remote students during live or recorded a broadcasted lesson; (c) A synchronization module for receiving all information sources from said lecturer's GUI and from said capture module and from other peripheral equipment for adding synchronization data; (d) a Database generation module for receiving the synchronized data, arranging and formatting said synchronized data for publishing and for building the database structure required for accessing live or on-demand lessons; (e) An Access rights module that communicates with predefined user-lessons database, for managing rights control and statistics; (f) a Bi-directional communication module for allowing text, voice and video communication between the lecturer in class and remote students and remote classes; and (g) a Student's GUI module for allowing a remote student to access, view, manage, participate and edit live and recorded lessons.

### FIELD OF THE INVENTION

The present invention relates to the field of video communication education. More particularly, the invention relates to a system for automatically capturing, producing and publishing frontal information from lecture halls for live and recorded lessons.

### BACKGROUND OF THE INVENTION

The most widespread education method was and probably will be, frontal lectures with several teaching accessories such as white or black board, slides, computer presentations such as Microsoft PowerPoint and various multimedia presentations from many sources, such as simulations, web pages, video clips and more. As the computing and communication technologies, improves, more and more people consume information by their appliances (e.g., PCs, laptops and PDAs), there is an increasing demand for accessing educational material at any time and from any place. In order to meet that demand, educational institutes need to capture, produce and publish huge amount of complex information from its lecture halls. Doing so entails extremely demanding operation, since most of the process is manual and required cameramen, video editors, and database operators. In addition, the user (a student) needs to have complementary tools to enhance its study process. He needs to be able to search, jump, mark, index and add his own material to the original lesson and in the same time to communicate with the lecturer and to share information with other remote students.

Standard tracking algorithms (such as those disclosed in U.S. Pat. No. 7,349,008), can handle only a single object at a time. However, in lectures hall the system must handle scenarios that more than one object should be followed. There are some conventional solutions (such as those disclosed in US 2007/0081080) that use preset conditions to handle this problem, but the preset position requires a-priory knowledge about what is going to happen in the classroom, which generally is not available.

All the methods described above have not yet provided satisfactory integrative solution to the problem of automatically capturing, producing and publishing frontal complex information from lecture halls.

It is an object of the present invention to provide a system for automatically capturing, producing and publishing frontal information from lecture halls, that allow business and educational institutes to generate and publish live or on-demand presentations and lectures to its audience.

It is another object of the present invention to provide a system for automatically capturing, producing and publishing frontal information from lecture halls, which tracks the lecturer in the lectures hall.

It is a further object of the present invention to provide a system for automatically capturing, producing and publishing frontal information from lecture halls, that analyzes the lecturer speed, location and direction in space.

It is yet another object of the present invention to provide a system for automatically capturing, producing and publishing frontal information from lecture halls, that determines the optimal zoom, pan and tilt values of the video camera in every moment.

It is still another object of the present invention to provide a system for automatically capturing, producing and publishing frontal information from lecture halls, that is capable of synchronizing between different captured multiple video sources.

Other objects and advantages of the invention will become apparent as the description proceeds.

### SUMMARY OF THE INVENTION

The present invention is directed to a system for automatically capturing, producing and publishing frontal information from lecture halls, that comprises:

a) a Lecture hall capture module, consisting of video cameras, microphones peripheral equipment and video analysis software for capturing of an on-going event in the hall;
b) a Lecturer GUI module for allowing the lecturer to add data into the lesson database, to control the capturing components to control the database generation, to control the database upload process and to communicate with remote students during live or recorded a broadcasted lesson;
c) A synchronization module for receiving all information sources from the lecturer's GUI and from the capture module and from other peripheral equipment for adding synchronization data;
d) a Database generation module for receiving the synchronized data, arranging and formatting the synchronized data for publishing and for building the database structure required for accessing live or on-demand lessons;
e) An Access rights module that communicates with predefined user-lessons database, for managing rights control and statistics;
f) a Bi-directional communication module for allowing text, voice and video communication between the lecturer in class and remote students and remote classes; and
g) a Student's GUI module for allowing a remote student to access, view, manage, participate and edit live and recorded lessons.

The Student's GM module is used to perform one or more of the following operations:

a) allowing a remote student to search in each of the video streams/sources and de-synchronize the video streams/sources and in any point, to re-synchronize them to the new selected point;
b) allowing a remote student to decided in every moment what will be the content of each of the video windows, and to full screen each of the video windows, while keeping the hidden video synchronized;
c) allowing a remote student to de-synchronize and re-synchronize between lecturer PC thumbnails and the video streams, so as to remove and to add each of the information sources to and from the synchronous flow.

The student interface may comprise multiple video windows, being video sources taken from local files or streaming video.

The peripheral equipment may include a digital pen, a digital whiteboard or an external DVD.

The Lecture hall capture module may further include a laser pointer.

The Access rights module and the Student's GUI module may be web based applications.

The Lecturer GUI may include a bi-directional voice and textual chat interface.

Lesson selection may be performed by:

a) providing indication to the user whether a live lesson is currently taking place;
b) displaying a hierarchical list of all the student's recorded lessons;
c) displaying general information blow the live lesson indication window;
d) searching the database for currently authorized live and recorded lessons;
e) generating updated “lessons list”;
f) allowing the student to “join live lesson” by presses the “join live lesson” button;
g) displaying a user interface for live bi-directional lectures, that is connected to a web based access system; and
h) allowing the user to access the lecturer's recorded or live video, the lecturer recorded or live PC screen, in addition to all the files and relevant links that were chosen by the lecturer.

Whenever a remote student has a question to the lecturer, he may initiate a chat and in turn, the distribution scheme for this student is dynamically replaced by a P2P connection.

Whenever the remote student terminates the chat, the P2P connection is closed and return back to video server distribution scheme, while during this time, all other participants continue to use the broadcast distribution scheme without any interference.

Whenever the lecturer aims his laser pointer to a point, the “class analysis” algorithm identifies the laser beam and re-directs the camera to zoom in on the area surrounding the point.

A student can share his personal information with other students or use it as Meta bookmarks for later use.

Automatic and synchronized thumbnails may be generates from the lecturer PC screen, according the selected window.

The lesson may be automatically indexed and sliced every time the lecturer presses the break button.

The system may allow the lecturer and the student to insert abstract and layered multimedia notes to each lesson slice, wherein the notes are automatically synchronized and displayed in the student interface.

The system may allow the student to search the database for relevant information, wherein the search runs on the text entered by the lecturer and on the text that was generated automatically by the system and on the text entered by the student.

The system may generate an automatic panoramic views collection per lesson of the class black/white board, while being synchronized to the lesson database.

The lecturer's GUI allows performing one or more of the following operations:
Select lesson name
Select lesson number
Add a link for sharing
Add files for sharing
Select lesson inputs, Cam/Computer screen/voice/video clip
Live broadcast
Enable student voice for live lessons
Start/Break lesson
Complete lesson
Upload lesson database automatically when lesson completed
Web page display of off-line broadcast lessons
Chat interface for live broadcast lessons
see live video audio of remote class
see and control in real time the local class camera

Whenever there are several traceable objects, both objects activities are compared and the highest activity object is tracked.

Pan, tilt and zoom control may be focused on the area containing the most relevant data.

The Class Capturing module may receive a wide angle view of the class and analyzes the incoming video data.

Multiple sources may be synchronized by taking the presentation content directly from the lecturer PC and converting the content in real-time to a video stream.

The system may allow thumbnails generation.

Unique compression algorithms may be performed on the content of the lecturer PC memory screen before transmitting it.

The system may allow using network architecture for synchronization.

The sources that are not generated on the same machine may also be synchronized.

The present invention is also directed to a method for automatically capturing, producing and publishing frontal information from lecture halls, that comprises the following steps:

a) transferring, by the client application, all the relevant information to the local station or directly to the broadcast servers;
b) activating the capturing devices by the local station;
c) activating a synchronization process between all information sources;
d) building a lesson data base and performing data conversions;
e) connecting to central web and video servers for live broadcasting; and
f) allowing the lecturer to start, pause and stop teaching.

The camera may track the lecturer movement in the class, for maintaining the right capturing.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 schematically illustrates a Lecturer graphical user interface, according to a preferred embodiment of the invention;

FIG. 2 schematically illustrates a Lecturer graphical user interface that includes bi-directional chat interface, according to a preferred embodiment of the invention;

FIG. 3 schematically illustrates a live view and control of a local camera (in the same class) or a remote camera (from a remote class), according to a preferred embodiment of the invention;

FIG. 4 schematically illustrates a user (student) interface, connected to a web based access system, according to a preferred embodiment of the invention;

FIG. 5a schematically illustrates a user (student) interface for live bi-directional lectures that is connected to a web based access system, according to a preferred embodiment of the invention;

FIG. 5b schematically illustrates the user (student) interface sown in FIG. 5a, with layered multimedia notes that were added;

FIGS. 6 and 7 schematically illustrate a lesson selection, according to a preferred embodiment of the invention;

FIG. 8 schematically illustrates a login page, according to a preferred embodiment of the invention; and

FIG. 9 is a block diagram of the system proposed by the present invention.

### DETAILED DESCRIPTION OF PREFERRED EMBODIMENTS

### Definitions

Lecturer: By using the term “lecturer” it is meant to include any person that delivers new information to one or more persons who wishes to receive that information, in the form of a frontal session. The term is directed, inter alia, to include also teachers, guides, instructors, supervisors, conductors, trainers, coaches, directors, providers etc.

Student: By using the term “student” it is meant to include any person that receives new information from a lecturer, in the form of a frontal session. The term is directed, inter alia, to include pupils, trainees, interns, practitioners, customers, employees, players, actors etc.

Lecture Hall: By using the term “lecture hall” it is meant to include any area in which a lecturer delivers new information to one or more students who wish to receive that information, in the form of a frontal session. The term is directed, inter alia, to include also classrooms, theaters, indoor sitting rooms, outdoor sitting areas, conference centers, training rooms, etc.

The system proposed by the presented invention takes into consideration environmental characteristics such as projector's screen, LCD or other type of displays instruments that may influence the capturing system. Due to novel video analyzing algorithms and close integration with other systems inputs, the proposed system can perform a novel automatic video capturing at lectures environments. The proposed system also provides the lecturer a unique Graphical User Interface (GUI) for controlling the system functionality by up to 2 clicks. Is also provides the student a unique, installation free (assume the user have standard media player, such as “window media player”), web based interface that supports several live or on-demand streaming multimedia channels, files sharing and links to relevant web pages. The student interface allows the student to add personal information such as text, video bookmarks and synchronized layered multimedia notes, which are saved as multimedia data in one or more layers, that can be displayed later in a synchronized manner.

The system also enables the student to experience independent multiple video streams across the public web in a synchronous manner.

The system also enable the student to move each of the video streams to any time point in the lesson (also in different parts of the lesson) and by clicking the “sync” button, to synchronize the other video streams and all other relevant information to the new time point.

The system also enables the student to set bookmarks on each of the video sources, and the jump back to them at any time.

The system also enables the user to share his textual or multimedia notes with others,

These features significantly improve the learning process.

The ability to share the information he added, as well as the ability to add and share students notes (such as text, multimedia and bookmarks) enrich the database, keep it updated and make it much more attractive than an original lesson.

These features constitute a unique and powerful E-learning system that handles automatically all the aspects of capturing, storing, publishing and sharing lectures, while keeping this process transparent for the lecturers and student and yet significantly cheaper and easy to assimilate for the educational institutes, release the main bottlenecks and allow making education accessible at any time and from any place.

The proposed system handles all stages of capturing, synchronizing, combining, storing, publishing, varied data sources such as multiple streaming media, text, files, links and other digital data types. The system also allows voice over IP and textual communication between the remote students and the lecturer during live lessons. The system also enables full bi-directional communication, in real time, between two or more classes that uses the system, based on a combination of video+voice+text.

The system includes novel techniques that allow this process to be completely automatic, while reducing production and publishing costs.

### System Components

The proposed system comprises the following modules:
Lecture hall capture module: This module consists of, video cameras, microphones, laser pointer and video analysis software that generate a complete understanding and capturing of the on-going event.
Lecturer graphical user interface (GUI): This module allows easy operation by adding many types of data into the lesson database, controlling the capturing components and communicating with remote students on live broadcasted lessons.
Synchronization module: This module receives all information sources from lecturer's GUI and from the capture module and adds synchronization information.
Database generation module: This module receives the synchronized data, arranges and formats it for publishing. It also builds the relevant database structure for accessing that lesson, whether live or on-demand.
Access rights module; this module is a web based application that communicates with predefined, user-lessons database for managing rights control and statistics.
Bi-directional communication module: This module allows text and voice communication between the lecturer in class and remote students and between several remote classes with bi-directional multiple audio+video streams in real time.
Student's GUI: This module is a web based application that allows the remote student to access, view, manage and edit synchronized multiple video streams from live and recorded lessons also over the public web.

For example, whenever a lecture production and publishing is desired, the lecturer uses standard blackboard and various multimedia contents, such as Microsoft PowerPoint slides, relevant web pages and dynamic simulation, from his PC or Laptop. He also wants to share some files and internet links with his remote students and to make this lesson “live” on the public web for registered users only. It is also important to archive the lecture for later use.

The system also generates automatically periodical and content based thumbnails from the lecturer PC's screen and add them to the lesson database.

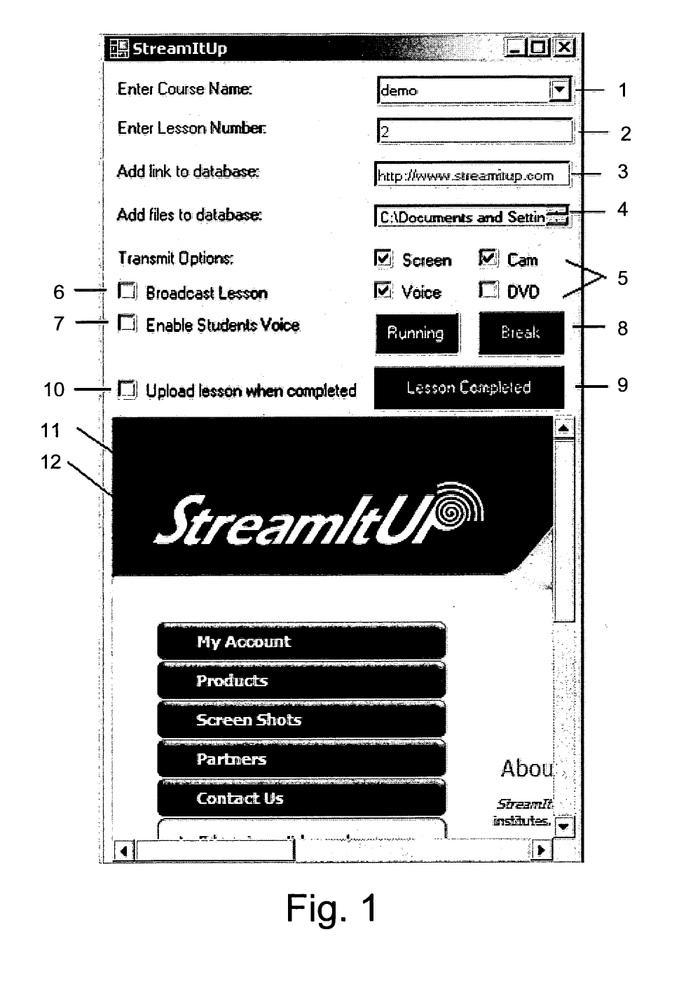

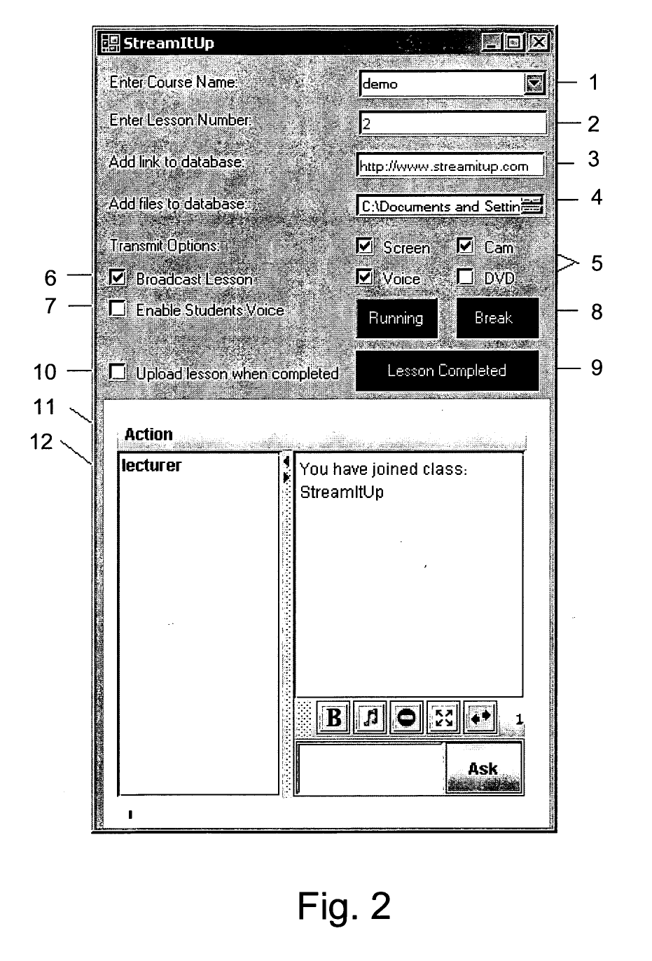

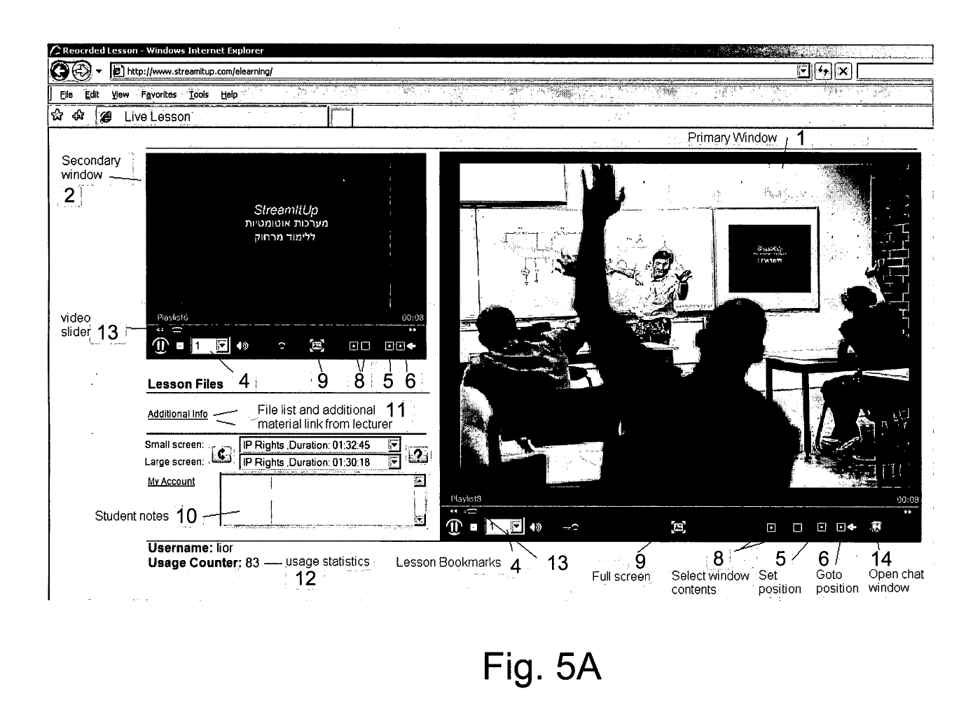

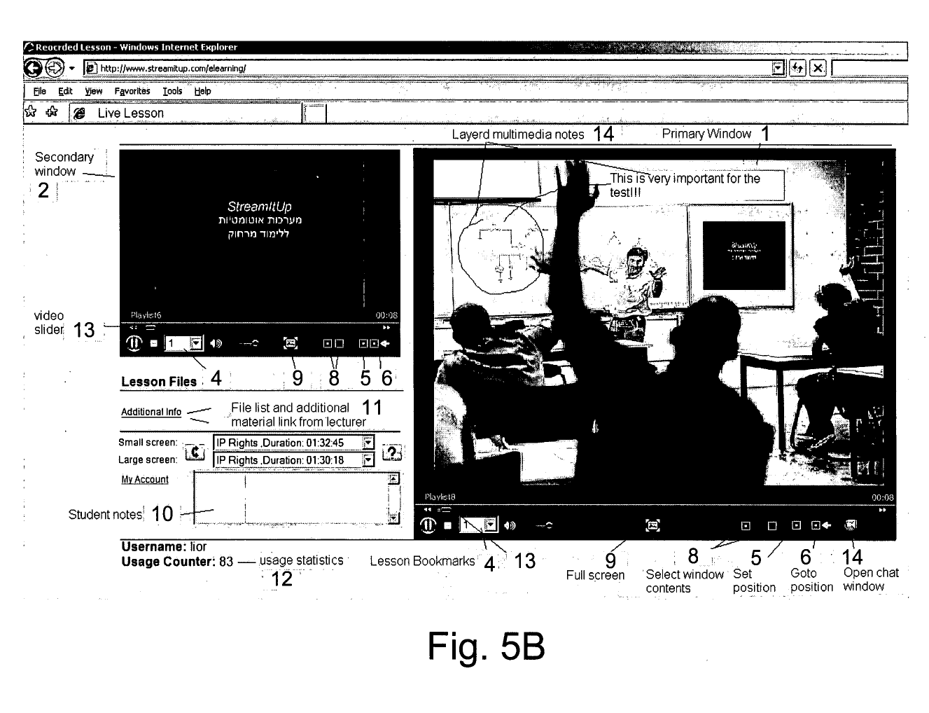

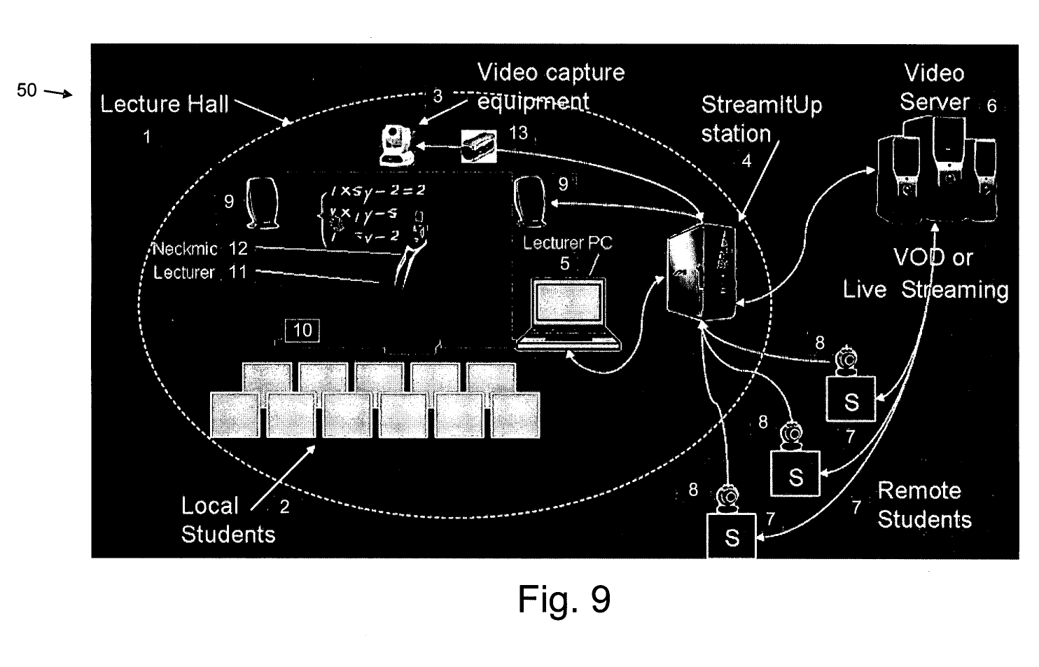

FIG. 2 schematically illustrates a Lecturer graphical user interface that includes bi-directional chat interface. FIG. 5 illustrates one time preparations required, the lecture class, the video and web server and the remote users. The figure, also describes the data and control flow. The system 50 is installed in a standard lectures hall (FIG. 9-[1]). The client application (shown in FIGS. 1, 2 and 3) are installed on the class PC or on laptop (FIG. 9-[5]) or other computer type. The educational institute loads the student/courses access authorization file into the presented system database (FIG. 9-[6]). The lecturer (FIG. 9-[11]) opens the lecturer GUI on the class PC (FIG. 9-[5]). He selects the lesson's name and number from a pull down menu (FIG. 2-[1,2]). Then he selects the desired files and links to share with his students from a built in browser window (FIG. 2-[3,4]). Then he press the “Start” button (FIG. 2-[8]) and start teaching. It is optional to select the required application window to be captured from the lecturer PC.

The system 50 now starts working, while automatically performing the following operations:
The client application transfer all the relevant information to the local station (FIG. 2-[4])
The local station (FIG. 2-[4]) activates the capturing devices such as cameras, microphones and screen captures (FIG. 2-[3,12]) and the class analysis algorithms (FIG. 9-[4]). At a default state, the camera tracks the lecturer movement in the class and keeps him in frame during the lecture.
The system activates a synchronization process between all information sources (FIG. 9-[3/13,5,12]). The station shown in (FIG. 9-[4]) is activated and starts building a lesson data base and performs data conversions. Then the system connects to central web and video servers for live broadcasting (FIG. 9-[6]). The lecturer starts teaching.

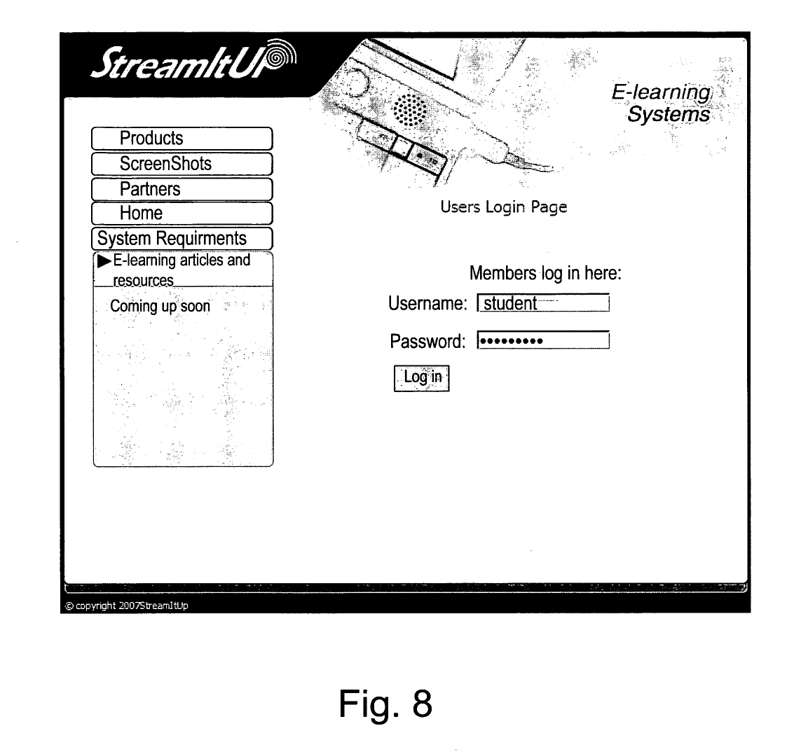

From the other side of the virtual lecture hall, a student (FIG. 9-[7]) wants to participate in the lesson. He inserts his username and password into the login page (as shown in FIG. 8, which schematically illustrates a login page, according to a preferred embodiment of the invention). The system also supports entering the lesson selection interface by integrating the customer authentication process, while skipping the need for a login page. It also possible that the student will enter the database from the educational institute authentication system.

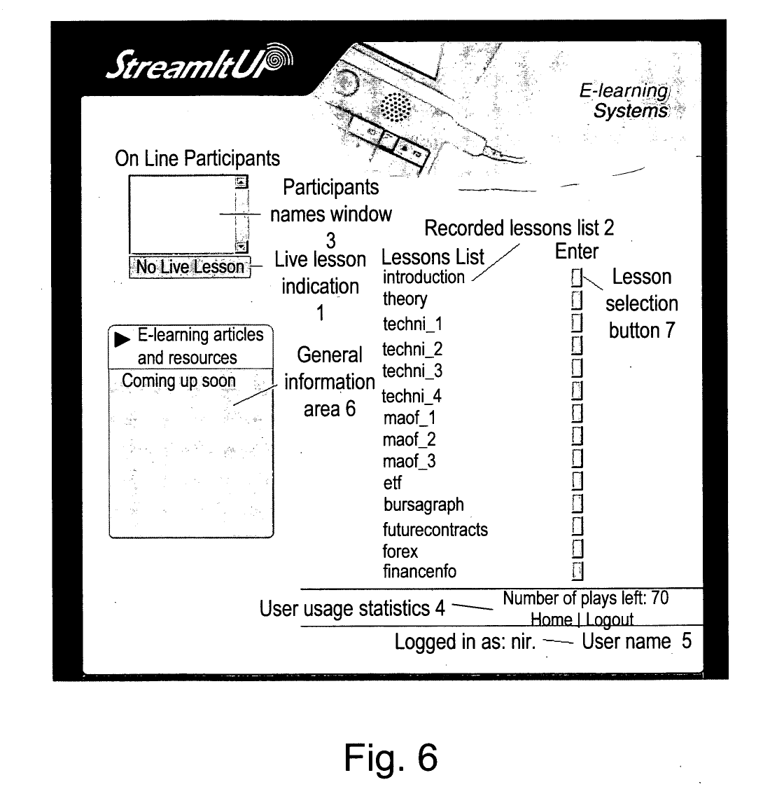

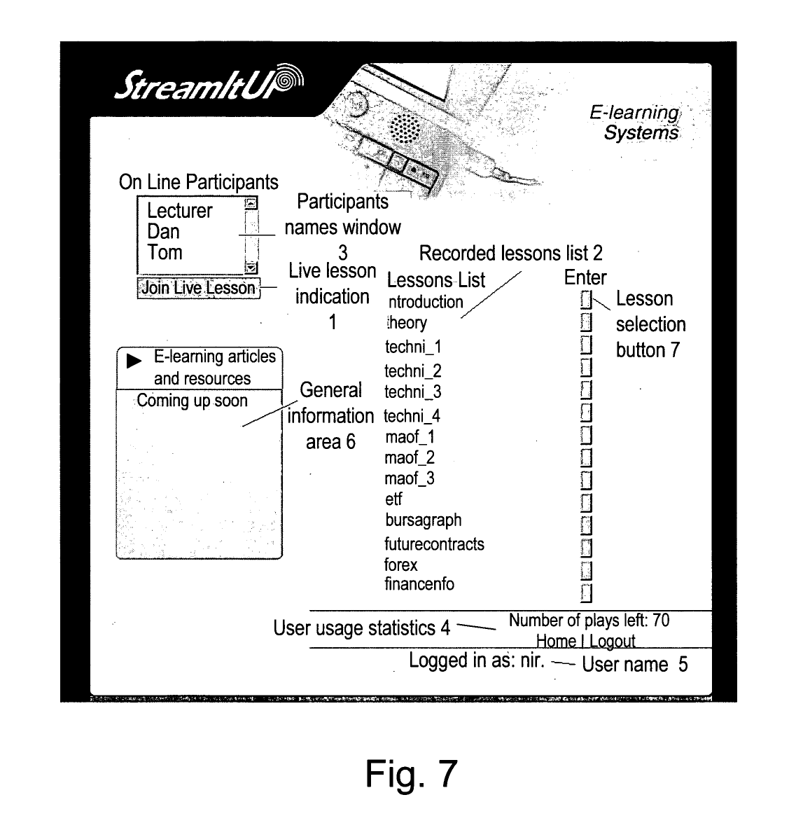

FIGS. 6 and 7 schematically illustrate a lesson selection, according to a preferred embodiment of the invention. In the upper left side, the system indicates the user whether a live lesson is currently taking place. In the right side there is a hierarchical list of all the student's recorded lessons. At the bottom, student access statistics is displayed. In addition, general information is displayed blow the live lesson indication window.

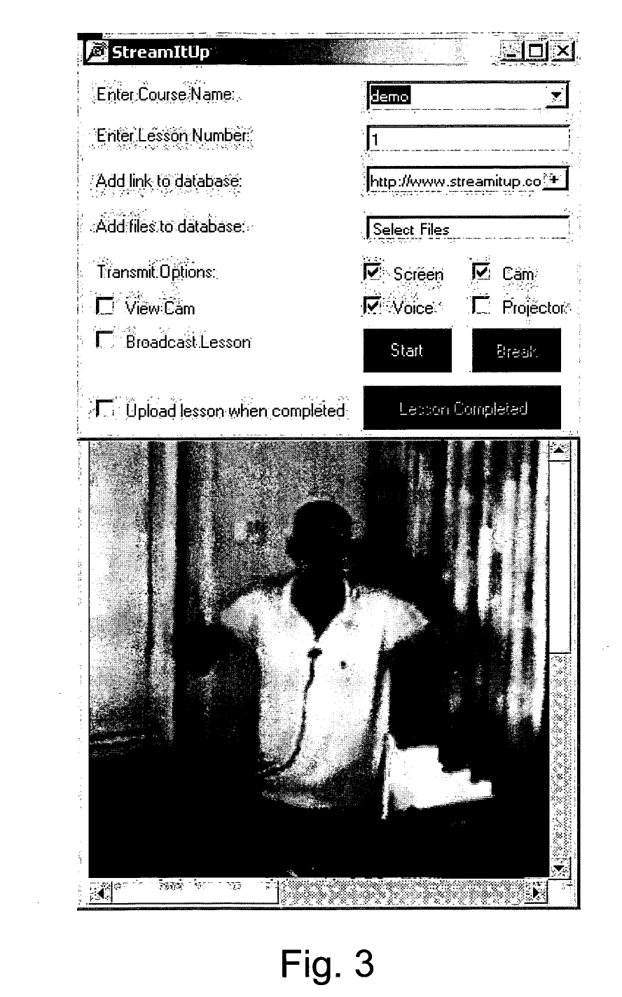

The system searches the database for currently authorized live and recorded lessons for this student and generates updated “lessons list” page (FIG. 3-[2]). Then the system invites the student to “join live lesson” (FIG. 7-[1]) and the student presses the “join live lesson” button. In response, the “live student access” window is opened (as shown in FIG. 5a, which schematically illustrates a user (student) interface for live bi-directional lectures that is connected to a web based access system).

At this stage the student receives all the information like he was sitting in the “real” lecture hall, including two synchronized multimedia streams: for example, one is the lecturer's video and the other reflects the lecturer PC screen. In addition, he gets all the files and relevant links that were chosen by the lecturer few seconds ago in the class. If the student likes to ask the lecturer a question, he presses the Chat icon (FIG. 5a-[14]) and in response, the system dynamically replaces the video server distribution scheme to P2P (Point TO Point) communication, directly from the student's location to the local station in the lecture hall (FIG. 9-[4]). This stage is required since the delay in standard video network is too long for voice chat. Then the lecturer and the students that are present in the class hear the student's question, as it was asked by one of them. The remote student sees and hears the answer. Then the remote student closes the Chat interface. At that moment, the system dynamically closes the P2P connection and returns to the video server distribution scheme.

If a “local” student (FIG. 9-[2]) asks the lecturer about a subject that was written on the other side of the board, the lecturer uses the direct camera control (FIG. 3) or his laser pointer to explain what was written there and the “class analysis” algorithm, identifies the laser beam and re-directs the camera to zoom in on that area for allowing remote students to focus on interesting points, as well, even if the lecturer is not standing there. During the lecture, the system looks for time periods when the lecturer is not hiding the board, takes snapshots of it and transfers the images to the database.

The lecture continues and after some time, the lecturer decides to take a break for several minutes. He presses the “Break” button (FIG. 2-[8]) and the system marks this point as the end of the current session in the recorded database. The system waits for more instructions, which can be “Continue” (after the first Break, the “Start” button is replaced by “Continue” button) or “Lesson completed” (FIG. 2-[8,9]). In that moment, the lesson is already a part of the “recorded” database and the remote student can review it by selecting it from the lessons' list (FIG. 7-[2]) and check if he understood the lesson correctly. The student can choose the new lesson from the updated lesson list (FIG. 7-[7]). He browses the multimedia presentation, (FIG. 2-[1,2,4,13,]) the automatic board snapshots, and bookmarks for some important points that he feels he would like to return to (FIG. 2-[5])). He adds some multimedia notes and remarks to specific time locations during the lesson and saves all of it into his student account (FIG. 2[4-10]). Now the student can share his personal information with other students or use it as Meta bookmarks for later use. Meanwhile, the break ended and the lecturer returns to class.

The lecturer presses the “Continue” button (FIG. 2-[8]). The system identifies that it is the next part of the same lecture and arranges the database accordingly. When the lesson ends, the lecturer presses the “lesson complete” button (FIG. 2-[9]). The system wraps and closes the database shuts-down all the capturing equipment and marks this lecture as “completed” in the database.

This way, the lecture was captured, synchronized, recorded and published live, including real-time chat, completely automatically.

### The Lecturer's GUI

Automatic lectures production requires managing and controlling large variety of data types and sources with minimal human interaction. Therefore, a lot of efforts were devoted for designing a control interface that will allow minimal human operation and yet will collect all the required information to have an automatic lectures production and sharing system.

FIG. 1 schematically illustrates a Lecturer graphical user interface, according to a preferred embodiment of the invention. This interface allows full control of the production and broadcasting process, but yet requires minimal operations from the lecturer in class. This interface allows the lecturer to control the system functionality. The lecturer only has to select the lesson's name and number from a roll down menu and press the “Start” and “break” (FIG. 1-[8]) buttons. All other functionalities are optional and allow advanced operations. The interface allows performing the following operations (As shown in FIGS. 1 and 2):

1. Select lesson name (FIG. 1-[1])
2. Select lesson number (FIG. 1-[2])
3. Add a link for sharing (FIG. 1-[3])
4. Add files for sharing (FIG. 1-[4])
5. Select lesson inputs, Cam/Computer screen/voice/video clip (FIG. 1-[5])
6. Live broadcast (FIG. 1-[6])
7. Enable student voice (for live lessons only) (FIG. 1-[7])
8. Start/Break lesson (FIG. 1-[8])
9. Complete lesson (FIG. 1-[9])
10. Upload lesson database automatically when lesson completed (FIG. 1-[10])
11. web page display (for non live broadcast lessons) (FIG. 1-[11])
12. Chat interface for live broadcast lessons (FIG. 2-[12])

### The Lecturer Tracking System (Motion Tracking, Zoom, Masking,)

This module tracks the lecturer movements and keeps him in frame as necessary. Motion tracking systems that are based on motion detection are used for lecturer tracking in lectures halls environment. Motion detection algorithms are based on comparing the differences between frame N and N-n, setting a threshold, and marking areas above that threshold as detected movements. Using such conventional algorithms in lecture halls that use projectors or large Plasma/LCD displays may lead to wrong detections, depends on the projected image activity. To overcome this problem, one might use constant masking predefined presets of this area (as described in US 2007/0081080) and by that exclude these areas from the detection algorithm even if no image is display on the projector or plasma/LCD screens. This may generate gaps in the tracking area and will cause jumpy video output. The system 50 solves this problem by using video analysis that receives data from a wide angle (reference) video source. A video capturing equipment (FIG. 9-[3]) is controlled to be adjusted to the required zoom, pan and tilt. In case when a high resolution wide angle source (FIG. 9-[13]) is used as the reference video source, the video capturing equipment (FIG. 9-[3]) may be only a redundant, The video analysis understands the characteristics of the lecture by using three inputs: The first is, predefined masking area the second is by using lecturer GUI indication which is a part that provides data about the lecturer nature (with or without “screen” (FIG. 1-[5])) and the third, by analyzing the scene behavior and using dynamic masking algorithm for generating new thresholds for the detection algorithm. The presented algorithm allows smooth tracking also in large “noisy” areas.

The presented invention also analyzes the lesson to control the zoom value, for example, when the lecturer is writing on the board—the camera need to zoom in, but when the lecturer is near a large projector screen—the camera needs to zoom out.

### Multiple Objects

The algorithm proposed by present invention actually mimics the human visual system. In case of a single object, the system tracks and zooms on this object. In case when additional movement is detected, its behavior and location are characterized and the system decides if it is another human (student or maybe another lecturer). If it is detected to be another traceable object, both objects activities are compared and the highest activity object is tracked (as long he is in the tracking area). In case when both objects have similar activity, the system zooms out to capture both of them in the same frame. This is a recursive algorithm and can work for several objects. Using this algorithm gives full flexibility to the lecture and keeps the system fully automatic.

### Zoom Control

When capturing a lecture, it is important to use all the available information in order to capture the most interesting data. A student that sits in the lecture hall uses all his senses to filter out and zoom-in on the relevant information. The student sees, hears and understands the lecture scenario. The system proposed by the present invention needs to “understand” the important points without understanding the content of the lecture. Therefore, the system 50 analyzes the lecturer's behavior by two parameters: movements (speed and direction) and location in space. The interpretation of the lecturer behavior influences the tracking camera location and zoom. For example, if the lecturer is very “jumpy” the camera will zoom-out. If he is standing near the blackboard and pointing on the board, the camera will zoom-in to that location. If he stands outside the board and/or the projectors screen areas, the cam will perform quick board scan, etc.

### Class Capturing Module (Board Snapshots, Laser Pointer),

This module receives a wide angle view of the class and analyzes the incoming video. There are three special scenarios that will cause the capture camera to leave the lecturer's tracking state.

1. A laser beam was detected and located inside the capture area but outside the current frame. In that scenario, the capture camera (PTZ), will leave its current position, will be directed to capture the relevant area and will follow the laser beam. When the laser beam turns off, the lecturer will return to be the main object and the camera will track his movements.
2. The lecturer is out of the board area for a specific time period and the board content has been changed from the last time this happened. In this case, the system will make a fast scan of the board and generate from it “stills” images.
3. The lecturer selected manual control from the lecturer GUI.

### Multiple Source Synchronization

One of the major challenges in automatic production of frontal lectures that includes PC based presentation is the synchronization process. The common way to synchronize video with PC based presentation is by using editing software, such as “Microsoft Producer” after the lecture complete. These applications allow opening two video files or one video file and one Microsoft PowerPoint file and to change the time line, in order to synchronize between them. Synchronized presentation systems are disclosed, for example in US 2008/0126943. However, these systems do not allow dynamic presentations and neither online broadcast. Instead, the presentation is converted to HTML format and saved. Therefore, it cannot display dynamic data. Since the paging commands are transferred to the viewer (and by that the next HTML page of the presentation is displayed), this solution cannot work in real-time because the presentation file must be processed during the lecture and only then it is converted to HTML format, so during the lecture, the presentation file is not available.

According to the present invention, the presentation content is taken directly from the PC screen memory and it is converted in real-time to a video stream. Therefore, the synchronization process can be preformed during the lecture period and eliminates the need for manual editing and also allows unlimited presentation types. Thus, everything the PC can display, can be captured, recorded, synchronized and broadcast in real-time.

One way for synchronizing video and presentation in real-time is by starting capturing both of them at the same time, on the same machine and continue with the recording until both of them end. This can work as long as the lecturer starts the PC presentation at the beginning of the lecturer and keeps it running until the lecture ends, but in many cases this constraint is not acceptable. Many times, the PC presentation is shorter than the lecture itself, and the lecturer starts it after the lecture starts. The system proposed by the present invention allows the lecturer to start and stop each of the sources by the using lecturer's GUI (FIG. 1-[5]), since many times he wants to keep all sources synchronized. This is done by inserting fillers in time-slots between the different input sources. By filling the right gap, the output streams become synchronized and continuous.

An additional constraint in existing application and publications (such as those disclosed in (US 2004/0002049)) is that the video capture device and the PC presentation must run on the same machine. This is acceptable as long as low resolution video is required. When high resolution video should be captured (like during frontal lectures), the video capture machine must be independent of the lecturer's standard PC, due to three practical reasons: Firstly, the capturing and encoding processes for broadcast quality require a lot of processing power and dedicated video capture hardware. Both of them may not be included in a standard PC or laptop. Therefore, it should run on dedicated machine. Secondly, the connectivity between the camera and the corresponding encoder is sensitive and require special connections, wiring and capturing hardware that generally do not exist in standard PCs or on the lecturer's laptop. Thirdly, in some scenarios it is better to use dedicate encoding hardware or even to use one powerful machine to encode several cameras that might belong to different lectures halls. These examples emphasize the motivation to separate the lecturer's PC (which encodes the screen images) from the camera's encoder.

The system proposed by the present invention solves these problems by using network architecture. A central control panel that is installed on the lecturer's PC (FIG. 9-[5]), which is also the lecturer's GUI (shown in FIG. 1), receives all the commands from the lecturer. The lecturer's GUI activates a network client agent that communicates with the network server application (FIG. 9-[4]). Both network applications (server and at least one client) send and receive control and status indications that allow capturing, encoding, broadcasting and the synchronization of both machines (lecturer PC and high resolution camera encoder and streamer) without any limitation on the presentation type. This is done in completely automatic way and in real-time.

### Bi-Directional Communication:

The standard and well known method for allowing video and audio bi-directional communication over the web is by using low delay compression and distribution technologies. The main drawback of these technologies is the “built-in” relatively low image quality, compared to high delay technologies. The reason is a trade-off between the amount of buffering in the system (encoder, server and player) and the reconstructed image quality. When transmitting multimedia on congested networks (like the internet), some multimedia packets are dropped on the way and as a result, the reconstructed image quality is deteriorated. The severity of this problem depends on the network status. Therefore, the preferred way to broadcast multimedia on the internet is by using communication methods that allow re-transmission of the dropped packets. To do so, the communication network has to keep a buffer with the size of “Round Trip Delay”, which may be about 10-15 Sec. On the other hand, a delay of 10-15 sec is not acceptable for bi-directional voice chat which requires a maximum delay of 1 sec. Existing technologies choose one of the networks schemes and compromise on reduced image quality with low delay bi-directional communication, or only on one way broadcast. The method proposed by the present invention overcomes this problem by dynamically switching between these two communication methods. The default broadcasting method uses common multimedia network systems, such as Microsoft Media Encoder and Windows Server or Real Networks suite. These systems provide high quality video within 10-15 sec delay. Therefore, when a student wants to ask a question, the system 50 switches temporarily to low delay P2P connection directly to the class unit (FIG. 9-[4]) in the lecture hall. During the conversation, the student experiences low delay communication with a reasonable image quality. The rest of the remote students continue to experience high quality video and sound. When the conversation ends, the system 50 will roll back to its default high quality network.

An additional advantage of using dynamic switching instead of static low delay networks, is the system's cost and flexibility. Existing low delay networks use the encoding station (which is the lecture hall, in our case) as the distribution point to eliminate the additional distribution server delay. This architecture implies that the educational institute has to guaranty very high and unknown bandwidth from each lecture hall (number of remote student times the video bit rate). On the other hand, by using the proposed dynamic switching, the video distribution is done outside the lecture hall by a video server that can be optimally located in the network backbone. Only when a student has a question, the “lecture hall” bandwidth need to be slightly increased, up to maximum of 2 times the video bit-rate.

### Student's Interface

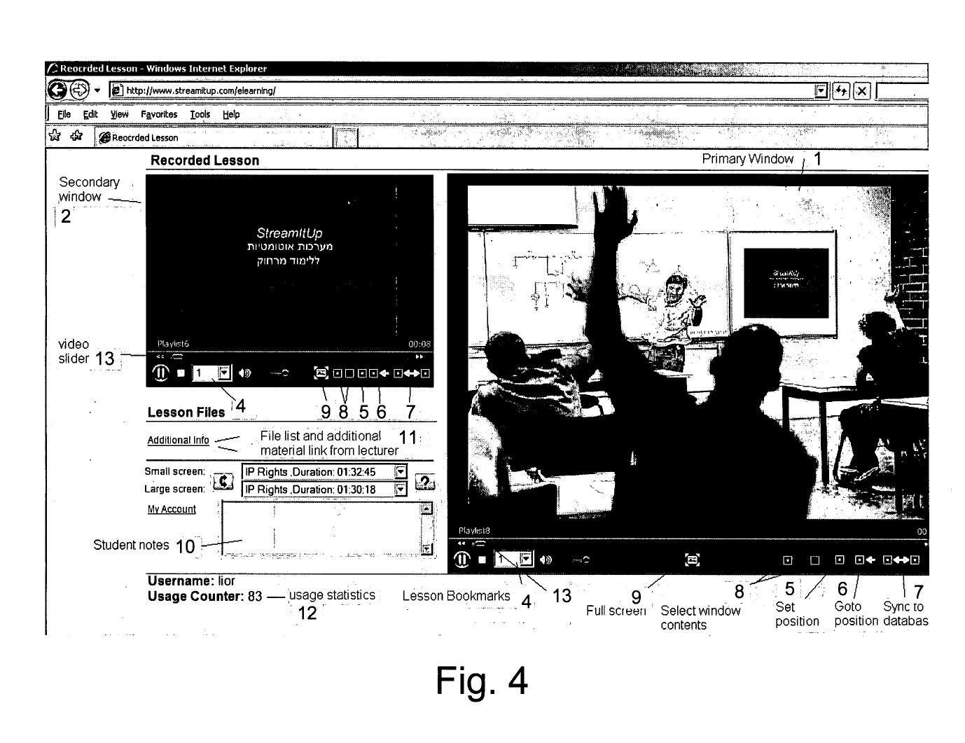

FIG. 4 schematically illustrates a user (student) interface, connected to a web based access system that manages most of the students' operations. The student interface supports the following functionalities:
Display two synchronized video streams ((FIG. 2-[1,2])) over the public network (Internet) while keeping the streams synchronized even in a congested network. Keeping separate video streams synchronized when one or even both of them suffer from different propagation delay in the network or any other network problems is problematic. The system proposed by the present invention overcomes these problems by monitoring the streams status and balance both streams by holding one stream, until the other stream reaches the same point. Only then it releases the first stream. This way, the multimedia streams remain synchronized also under bad network conditions.
Allow the user to move the player's timeline slider (FIG. 2-[13]) in each video stream independently, for searching interesting point, while keeping the other video stream continuously played.
Each video stream can be placed in different time location, by pressing the “sync” button (FIG. 2-[7]). The entire database will be re-synchronized to the desired point. The strait forward solution is to transmit the required time point both to the database and to the video server and by that to re-synchronize the video streams. However, this solution is not sufficient for public networks, due to the long delay of the network. Buffering will generate constant delay between the local video and the new video that need to be streamed from the remote server. To overcome this problem, the “student interface” application (shown in FIG. 4) monitors the status of each video stream and sends the relevant commands both to the remote video server and to the local player, until the video streams and all other data are aligned and re-synchronized.
Enable access to links and files that was added by the lecturer, during lecture or at any other time (FIG. 2-[11]).
Add synchronized personal text (FIG. 2-[10]), while watching the lesson, both live and on-demand and save it in the system database for later use.
Add video bookmarks for each of the video streams, and save it in the system database for later use (FIG. 2-[5])
Share personal information, such as video bookmarks and lecture notes, with other users.
Reflect the lecture sessions as was indexed automatically during the lecture. The user is able to jump to the desired session directly from a pull down menu (FIG. 2-[4])
Add temporary bookmark to each video stream and jump to it at any time by pressing the “jumpto” button (FIG. 2-[5,6])
Add layered multimedia notes—(FIG. 5b-[14])
Dynamically set the content of each media player (FIG. 2-[8]). This feature allows the user to fit the viewer windows (FIG. 2[1,2]) to the lecture nature. If the presentation video stream is more important than the lecturer video, the lecturer video will be displayed in the smaller display and the presentation will be directed to the bigger video window (FIG. 2[1,2]) and vice versa. The user can also choose to watch the same video in both windows, search in one of them and re-synchronize the other accordingly exactly in the same manner as it was two different streams. This feature might be very useful if the lecture is based mainly on slides with the lecturer voice, and the user does not want to loose the lecture sequence but still want to search different topic.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1. A system for automatically capturing, producing and publishing frontal information from lecture halls, comprising:
a) a Lecture hall capture module, consisting of video cameras, microphones peripheral equipment and video analysis software for capturing of an on-going event in said hall;
b) a Lecturer GUI module for allowing said lecturer to add data into the lesson database, to control the capturing components to control the database generation, to control the database upload process and to communicate with remote students during live or recorded a broadcasted lesson;
c) A synchronization module for receiving all information sources from said lecturer's GUI and from said capture module and from other peripheral equipment for adding synchronization data;
d) a Database generation module for receiving the synchronized data, arranging and formatting said synchronized data for publishing and for building the database structure required for accessing live or on-demand lessons;
e) An Access rights module that communicates with predefined user-lessons database, for managing rights control and statistics;
f) a Bi-directional communication module for allowing text, voice and video communication between the lecturer in class and remote students and remote classes; and
g) a Student's GUI module for allowing a remote student to access, view, manage, participate and edit live and recorded lessons.

2. A system according to claim 1, wherein the Student's GUI module is used to perform one or more of the following:
a) allowing a remote student to search in each of the video streams/sources and de-synchronize said video streams/sources and in any point, to re-synchronize them to the new selected point.
b) allowing a remote student to decided in every moment what will be the content of each of the video windows, and to full screen each of said video windows, while keeping the hidden video synchronized;
c) allowing a remote student to de-synchronize and re-synchronize between lecturer PC thumbnails and the video streams, so as to remove and to add each of the information sources to and from the synchronous flow;

3. A system according to claim 1, wherein the student interface comprises multiple video windows, being video sources taken from local files or streaming video.

4. A system according to claim 1, wherein the peripheral equipment includes a digital pen, a digital whiteboard or an external DVD.

5. A system according to claim 1, wherein the Lecture hall capture module further includes a laser pointer.

6. A system according to claim 1, wherein the Access rights module and the Student's GUI module are web based applications.

7. A system according to claim 1, wherein the Lecturer GUI includes a bi-directional voice and textual chat interface.

8. A system according to claim 1, wherein lesson selection is performed by:
a) providing indication to the user whether a live lesson is currently taking place;
b) displaying a hierarchical list of all the student's recorded lessons;
c) displaying general information blow the live lesson indication window;
d) searching the database for currently authorized live and recorded lessons;
e) generating updated “lessons list”;
f) allowing the student to “join live lesson” by presses the “join live lesson” button;
g) displaying a user interface for live bi-directional lectures, that is connected to a web based access system; and
h) allowing said user to access the lecturer's recorded or live video, the lecturer recorded or live PC screen, in addition to all the files and relevant links that were chosen by the lecturer.

9. A system according to claim 1, in which whenever a remote student has a question to the lecturer, he initiates a chat and in turn, the distribution scheme for this student is dynamically replaced by a P2P connection.

10. A system according to claim 9, in which whenever the remote student terminates the chat, the P2P connection is closed and return back to video server distribution scheme, while during this time, all other participants continue to use the broadcast distribution scheme without any interference.

11. A system according to claim 1, in which whenever the lecturer aims his laser pointer to a point, the “class analysis” algorithm identifies the laser beam and re-directs the camera to zoom in on the area surrounding said point.

12. A system according to claim 1, in which a student can share his personal information with other students or use it as Meta bookmarks for later use.

13. A system according to claim 1, in which automatic and synchronized thumbnails are generates from the lecturer PC screen, according the selected window.

14. A system according to claim 1, in which the lesson is automatically indexed and sliced every time the lecturer presses the break button.

15. A system according to claim 1, which enables the lecturer and the student to insert abstract and layered multimedia notes to each lesson slice, wherein said notes are automatically synchronized and displayed in the student interface.

16. A system according to claim 1, which enables the student to search the database for relevant information, wherein the search runs on the text entered by the lecturer and on the text that was generated automatically by said system and on the text entered by the student.

17. A system according to claim 1, which generates an automatic panoramic views collection per lesson of the class black/white board, while being synchronized to the lesson database.

18. A system according to claim 1, in which the lecturer's GUI allows performing one or more of the following operations:
Select lesson name
Select lesson number
Add a link for sharing
Add files for sharing
Select lesson inputs, Cam/Computer screen/voice/video clip
Live broadcast
Enable student voice for live lessons
Start/Break lesson
Complete lesson
Upload lesson database automatically when lesson completed
Web page display of off-line broadcast lessons
Chat interface for live broadcast lessons
see live video audio of remote class
see and control in real time the local class camera

19. A system according to claim 1, wherein whenever there are several traceable objects, both objects activities are compared and the highest activity object is tracked.

20. A system according to claim 1, in which pan, tilt and zoom control is focused on the area containing the most relevant data.

21. A system according to claim 1, in which the Class Capturing module receives a wide angle view of the class and analyzes the incoming video data.

22. A system according to claim 1, in which multiple sources are synchronized by taking the presentation content directly from the lecturer PC and converting said content in real-time to a video stream.

23. A system according to claim 22, in which thumbnails are generated.

24. A system according to claim 1, wherein unique compression algorithms are performed on the content of the lecturer PC memory screen before transmitting it.

25. A system according to claim 1, in which network architecture is used for synchronization.

26. A system according to claim 18, in which the sources that are not generated on the same machine are synchronized.

27. A method for automatically capturing, producing and publishing frontal information from lecture halls, comprising:
a) transferring, by the client application, all the relevant information to the local station or directly to the broadcast servers;
b) activating the capturing devices by the local station;
c) activating a synchronization process between all information sources;
d) building a lesson data base and performing data conversions;
e) connecting to central web and video servers for live broadcasting; and
f) allowing the lecturer to start, pause and stop teaching.

28. A method according to claim 27, wherein the camera tracks the lecturer movement in the class, for maintaining the right capturing.
